(19) United States
(12) Patent Application Publication
(10) Pub. No.: US 2022/0067598 A1
(43) Pub. Date: Mar. 3, 2022

(54) SYSTEM FOR DETERMINING RESOURCE ALLOCATION BASED ON USAGE ATTRIBUTE DATA

(71) Applicant: Bank of America Corporation, Charlotte, NC (US)

(72) Inventors: Victoria L. Dravneek, Charlotte, NC (US); Jill Marie Moser, Louisville, KY (US); Matthew Murphy, Charlotte, NC (US); Matthew Robert Gray Pitner, Alpharetta, GA (US); Karen Lea MacQueen, Lyndhurst, OH (US); Brandy Lachole Brown, Charlotte, NC (US)

(73) Assignee: Bank of America Corporation, Charlotte, NC (US)

(21) Appl. No.: 17/002,085

(22) Filed: Aug. 25, 2020

(51) Int. Cl. G06Q 10/06; G06Q 30/02

(52) U.S. Cl. CPC G06Q 10/0631; G06Q 30/0203

(57) ABSTRACT

Embodiments of the present invention provide a system for determining resource allocation based on usage attribute data. The system is configured for determining one or more attributes associated with a user, generating a template associated with the user using the one or more attributes, comparing the template with one or more third party templates, determining a match between the template and a third party template of the one or more third party templates, and presenting a resource associated with the third party template to the user.

### BACKGROUND

Conventional systems do not have the ability to provide resources that are tailored to each user based on different attributes. As such, there exists a need for a system to determining allocation of resources based on attribute data.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for determining resource allocation based on usage attribute data. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention determines one or more attributes associated with a user, generates a template associated with the user using the one or more attributes, compares the template with one or more third party templates, determines a match between the template and a third party template of the one or more third party templates, and presents a resource associated with the third party template to the user.

In some embodiments, the present invention receives one or more third party attributes from one or more third party entities via a dashboard and generates the one or more third party templates using the one or more third party attributes received from the one or more third party entities.

In some embodiments, the present invention compares the template with the one or more third party templates based on comparing the one or more attributes in the template with the one or more third party attributes associated with the one or more third party templates.

In some embodiments, the present invention determines the match between the template and the third party template based on determining a match between at least one attribute of the one or more attributes with at least one third party attribute of the one or more third party attributes.

In some embodiments, the present invention determines the one or more attributes based at least one of historical interaction data, historical resource usage data, and location data.

In some embodiments, the template is a queryable template.

In some embodiments, presenting the resource associated with the third party template comprises transmitting the resource to an entity application and applying the resource to at least one resource pools.

In some embodiments, the present invention generates a questionnaire associated with at least one attribute of the one or more templates, receives an input associated with the questionnaire from the user, and updates the template based on the input received from the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for determining resource allocation based on usage attribute data, in accordance with an embodiment of the invention;

FIG. 2 provides a block diagram illustrating the entity system 200 of FIG. 1, in accordance with an embodiment of the invention;

FIG. 3 provides a block diagram illustrating a tailored resource allocation system 300 of FIG. 1, in accordance with an embodiment of the invention;

FIG. 4 provides a block diagram illustrating the computing device system 400 of FIG. 1, in accordance with an embodiment of the invention; and

FIG. 5 provides a flowchart illustrating a process flow for determining resource allocation based on usage attribute data, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “entity” may include any organization that processes financial transactions including, but not limited to, banks, credit unions, savings and loan associations, investment companies, stock brokerages, insurance companies and the like. In accordance with embodiments of the invention, the terms “third party system” and “other third party systems” may be associated third party entities that may include any organizations that provide products, goods, or services to one or more users. Furthermore, embodiments of the present invention use the term “user” or “customer.” It will be appreciated by someone with ordinary skill in the art that the user or customer may be a customer of the financial institution or a potential customer of the financial institution or an employee of the financial institution.

In accordance with embodiments of the invention, a “resource pool” or an “account” is the relationship that a customer has with an entity, such as a financial institution. Examples of accounts include a deposit account, such as a transactional account (e.g., a banking account), a savings account, an investment account, a money market account, a time deposit, a demand deposit, a pre-paid account, a credit account, a debit/deposit account, or the like. The account is associated with and/or maintained by the entity.

In accordance with embodiments of the invention, a “resource interaction” or an “interaction” may be transferring of funds from resource pools of the one or more users of the entity to one or more third party entities for goods, products, and/or services provided by the third party entities to the one or more users. In accordance with embodiments of the invention, a “resource” or “supplemental resources” may include but are not limited to rewards, reward points, discounts, offers, or the like.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more resources or portions of a resource. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

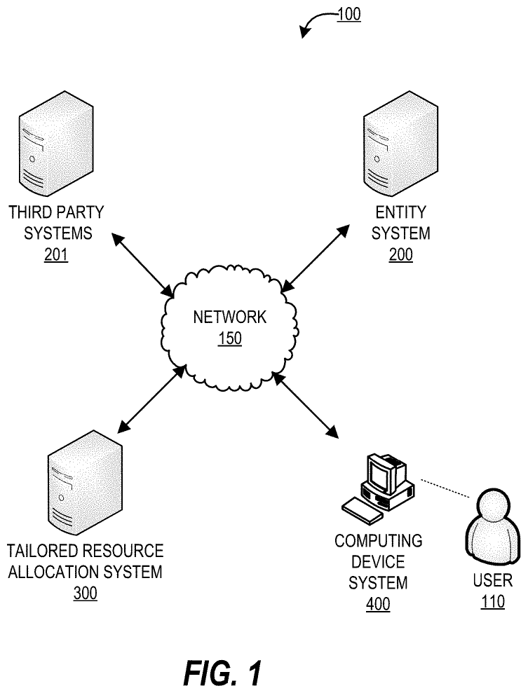

FIG. 1 provides a block diagram illustrating a system environment 100 for determining resource allocation based on usage attribute data, in accordance with an embodiment of the invention. As illustrated in FIG. 1, the environment 100 includes a tailored resource allocation system 300, entity system 200, a computing device system 400, and third party systems 201. One or more users 110 may be included in the system environment 100, where the users 110 interact with the other entities of the system environment 100 via a user interface of the computing device system 400. In some embodiments, the one or more user(s) 110 of the system environment 100 may be customers and/or potential customers of an entity associated with the entity system 200.

The entity system(s) 200 may be any system owned or otherwise controlled by an entity to support or perform one or more process steps described herein. In some embodiments, the managing entity is a financial institution. In some embodiments, the entity system 200 may include one or more servers. Third party systems 201 may be any systems that provide goods, products, and/or services to the one or more users of the entity. In some embodiments, the third party systems 201 may be any systems associated with third parties that have partnered with the entity.

The tailored resource allocation system 300 is a system of the present invention for performing one or more process steps described herein. In some embodiments, the tailored resource allocation system 300 may be an independent system. In some embodiments, the tailored resource allocation system 300 may be a part of the entity system 200.

The tailored resource allocation system 300, the entity system 200, the computing device system 400, and/or the third party systems 201 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the tailored resource allocation system 300 is configured to communicate information or instructions with the entity system 200, the computing device system 400, and/or the third party systems 201 across the network 150.

The computing device system 400 may be a system owned or controlled by the entity of the entity system 200, the user 110, and/or a third party. As such, the computing device system 400 may be a computing device of the user 110. In general, the computing device system 400 communicates with the user 110 via a user interface of the computing device system 400, and in turn is configured to communicate information or instructions with the tailored resource allocation system 300, entity system 200, and/or the third party systems 201 across the network 150.

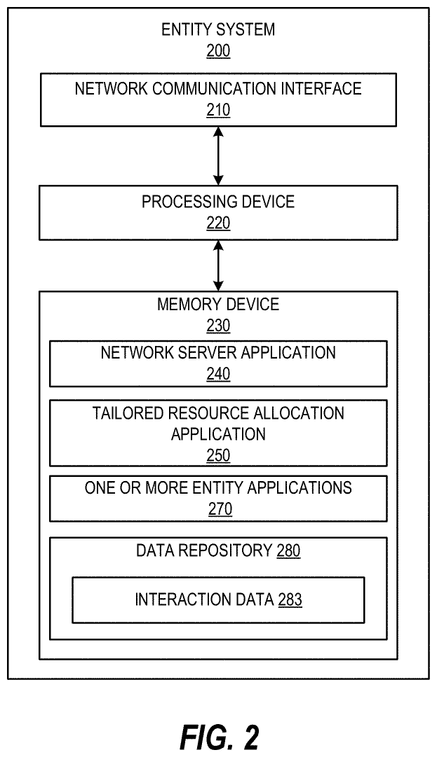

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a tailored resource allocation application 250, one or more entity applications 270, and a data repository 280 comprising interaction data 283. The computer-executable program code of the network server application 240, the tailored resource allocation application 250, the one or more entity applications 270, to perform certain logic, data-extraction, and data-storing functions of the entity system 200 described herein, as well as communication functions of the entity system 200.

The network server application 240, the tailored resource allocation application 250, the one or more entity applications 270, are configured to store data in the data repository 280 or to use the data stored in the data repository 280 when communicating through the network communication interface 210 with the tailored resource allocation system 300, the computing device system 400, and/or the third party systems 201 to perform one or more process steps described herein. In some embodiments, the entity system 200 may receive instructions from the tailored resource allocation system 300 via the tailored resource allocation application 250 to perform certain operations. The tailored resource allocation application 250 may be provided by the tailored resource allocation system 300. The one or more entity applications 270 may be any of the applications used, created, modified, and/or managed by the entity system 200. In one embodiment, an entity application may be an online banking application provided to the one or more users 110.

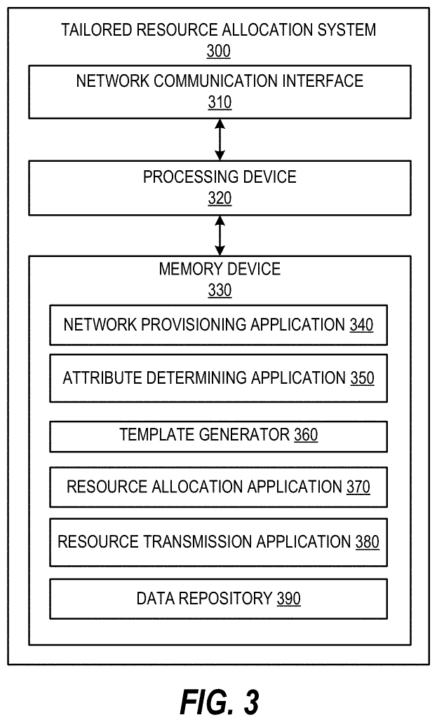

FIG. 3 provides a block diagram illustrating the tailored resource allocation system 300 in greater detail, in accordance with embodiments of the invention. As illustrated in FIG. 3, in one embodiment of the invention, the tailored resource allocation system 300 includes one or more processing devices 320 operatively coupled to a network communication interface 310 and a memory device 330. In certain embodiments, the tailored resource allocation system 300 is operated by a first entity, such as a financial institution, while in other embodiments, the tailored resource allocation system 300 is operated by an entity other than a financial institution. In some embodiments, the tailored resource allocation system 300 is owned or operated by the entity of the entity system 200. In some embodiments, the tailored resource allocation system 300 may be an independent system. In alternate embodiments, the tailored resource allocation system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the tailored resource allocation system 300 described herein. For example, in one embodiment of the tailored resource allocation system 300, the memory device 330 includes, but is not limited to, a network provisioning application 340, an attribute determining application 350, a template generator 360, a resource allocation application 370, a resource transmission application 380, and a data repository 390 comprising data processed or accessed by one or more applications in the memory device 330. The computer-executable program code of the network provisioning application 340, the attribute determining application 350, the template generator 360, the resource allocation application 370, and the resource transmission application 380 may instruct the processing device 320 to perform certain logic, data-processing, and data-storing functions of the tailored resource allocation system 300 described herein, as well as communication functions of the tailored resource allocation system 300.

The network provisioning application 340, the attribute determining application 350, the template generator 360, the resource allocation application 370, and the resource transmission application 380 are configured to invoke or use the data in the data repository 390 when communicating through the network communication interface 310 with the entity system 200, the computing device system 400, and/or the third party systems 201. In some embodiments, the network provisioning application 340, the attribute determining application 350, the template generator 360, the resource allocation application 370, and the resource transmission application 380 may store the data extracted or received from the entity system 200, the third party system 201, and the computing device system 400 in the data repository 390. In some embodiments, the network provisioning application 340, the attribute determining application 350, the template generator 360, the resource allocation application 370, and the resource transmission application 380 may be a part of a single application. The attribute determining application 350 determines one or more attributes associated with the one or more users 110. The template generator 360 generates one or more templates associated with the one or more users 110. The resource allocation application 370 identifies tailored resources associated with the one or more users 110 based on the templates generated by the template generator 360 and the attributes determined by the attribute determining application 350. The resource transmission application 380 may be responsible for transmitting the tailored resources identified by the resource allocation application 370 to an entity application provided by the entity to the one or more users 110.

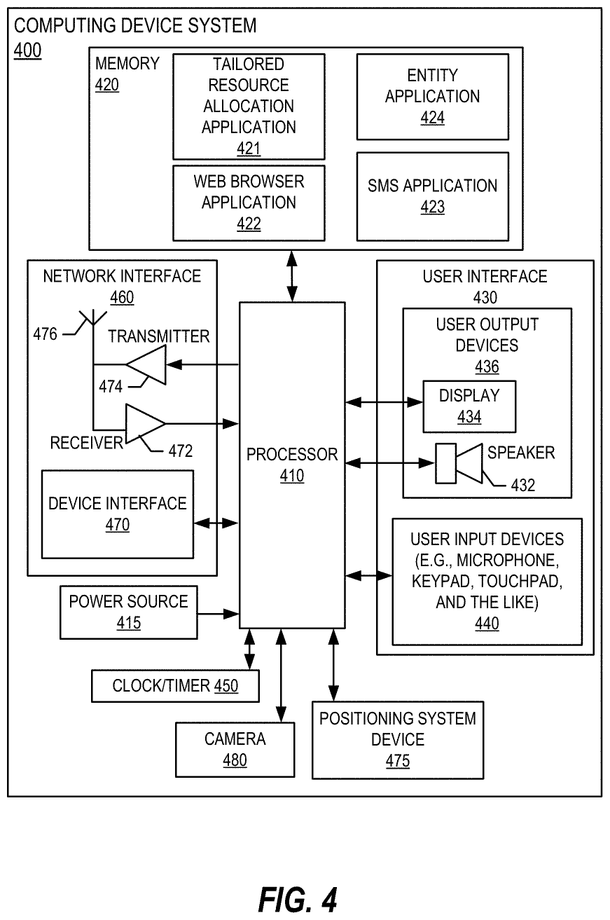

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a tailored resource allocation application 421, entity application 424. These applications also typically instructions to a graphical user interface (GUI) on the display 430 that allows the user 110 to interact with the entity system 200, the tailored resource allocation system 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the tailored resource allocation application 421 provided by the tailored resource allocation system 300 allows the user 110 to access the tailored resource allocation system 300. In some embodiments, the entity application 424 provided by the entity system 200. In some embodiments, the entity application 424 may be an online banking application. In some embodiments, the tailored resource allocation application 421 allow the user 110 to access the functionalities provided by the tailored resource allocation system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

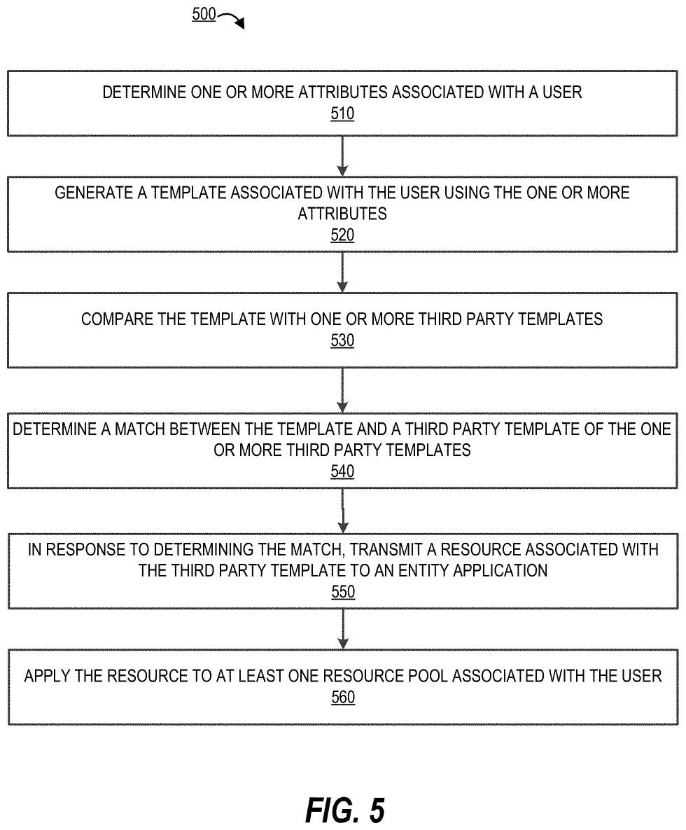

FIG. 5 provides a flowchart illustrating a process flow for determining resource allocation based on usage attribute data, in accordance with an embodiment of the invention. As shown in block 510, the system determines one or more attributes associated with a user. One or more attributes define the likes, dislikes, habits, living conditions, or the like of the user. The system may determine the one or more attributes based on at least one of historical interaction data, historical resource usage data, and location data. The system may extract historical interaction data, historical resource usage data from the entity system 200 and the location data from the entity application 424 in the computing device system 400. In some embodiments, the system after extraction, provides the historical interaction data, the historical resource usage data and the location data to an artificial intelligence engine. In some embodiments, the system may extract product level data associated with one or more historical interactions from a third party application associated with a partnered third party that collects receipts associated with the interactions of the user from the third party entities and/or the user.

In one example, the system may determine that the user has a pet based on the historical resource usage data. The historical resource usage data comprises one or more coupons that the user has used in the past. In another exemplary embodiment, the system may determine that the user like travelling to a destination ‘A’ every year based on the historical interaction data. Historical interaction data comprises historical financial transactions of the user. In another exemplary embodiment, the system may determine that the user has kids based on identifying that the user has visited a school based on the location data extracted from the computing device system of the user. The artificial intelligence engine may use any combinations of the historical interaction data, the historical resource usage data and the location data to determine the one or more attributes.

As shown in block 520, the system generates a template associated with the user using the one or more attributes. In some embodiments, the template generated by the system is a queryable template that allows faster comparison and retrieval of data. The template generated by the system allows any employee, application, or system of the entity to query any attribute data associated with the user using a software script. The software script may be provided by the employee application, or system of the entity. In some embodiments, the software script may be generated by the system based on a command presented by the employee application, or system of the entity. The templates include the one or more attributes and data associated with the one or more attributes. Maintenance of templates associated with each user allows the system to prevent existence of duplicate records or documents that contain repetitive information (e.g., user personal information or the like) within the entity system.

In some embodiments, the system may generate a questionnaire associated with any of the one or more attributes and present the questionnaire to the user via the entity application stored on the user computing device. For example, the system may determine that the user has a pet based on identifying that the user has used a coupon associated with pet supplies in the past. The system may then generate a questionnaire to know more about the pet (e.g., species, breed, type of breed, or the like). In some embodiments, the system may receive input from the user and may update the previously generated template based on the input received from the user. For example, the system may ask a questionnaire associated with a species and breed of the pet and then receive the inputs “dog” and “large” from the user. The system may then determine that the user has a large breed of dog and may update the template using the inputs provided by the user.

In some embodiments, the system may use the artificial intelligence engine/machine learning models to determine the one or more attributes and to generate the questionnaire. In some embodiments, when the system determines more than one match between the template and the one or more third party templates, the system calculates a probability of presenting one third party template over the other third party template via the artificial intelligence engine. In some embodiments, the artificial intelligence engine may be configured to implement any of the following applicable machine learning algorithms either singly or in combination: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and any other suitable learning style.

As shown in block 530, the system compares the template with one or more third party templates. The one or more third party templates may be generated by the system based on the third party attributes provided by one or more third party entities via a dashboard presented by the system. In one exemplary embodiment, the third party entities may provide offers, rewards, discounts, or the like associated with the products, goods, or services provided by the third party entities. The third party entities may specify one or more third party entity attributes which allow the system to identify type of the reward, category of the reward, or the like. The system compares the attributes in the template with the third party attributes in the one or more third party templates.

As shown in block 540, the system determines a match between the template and a third party template of the one or more third party templates. The system determines at least one attribute in the template matches with at least one third party attribute present in the one or more third party templates. For example, the system may determine a match between an attribute “dog” present in the template with the third party attribute “dog food” present in the one or more third party templates.

As shown in block 550, the system in response to determining the match, transmits a resource associated with the third party template to an entity application. Continuing with the previous example, the system transmits a discount associated with the third party attribute “dog food to the online banking application stored on the mobile device of the user. In some embodiments, when the system prompts the user to answer a questionnaire associated with the one or more attributes, the system may present additional resources to the user based on receiving inputs associated with the questionnaire. As shown in block 560, the system applies the resource to at least one resource pool associated with the user. Continuing with the previous example, the system may apply the reward to an account (e.g., credit card) that the user usually uses to perform interactions associated with the attribute “dog.”

Conventional systems typically provide generalized resources to all user of the entity. The system of the present invention instead of providing resources that are common to all different types of users, provides tailored resources based on probabilities derived by an artificial intelligence engine, where the probabilities allow the system to determine whether the user will use the presented resource or not. This eliminates the need to process, transmit, and store general resources that the user may not even use, thereby improving the efficiency of the entity systems and the computing device systems.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for determining resource allocation based on usage attribute data, the system comprising:
at least one network communication interface;
at least one non-transitory storage device; and
at least one processing device coupled to the at least one non-transitory storage device and the at least one network communication interface, wherein the at least one processing device is configured to:
determine one or more attributes associated with a user;
generate a template associated with the user using the one or more attributes;
compare the template with one or more third party templates;
determine a match between the template and a third party template of the one or more third party templates; and
present a resource associated with the third party template to the user.

2. The system of claim 1, wherein the at least one processing device is configured to:
receive one or more third party attributes from one or more third party entities via a dashboard; and
generate the one or more third party templates using the one or more third party attributes received from the one or more third party entities.

3. The system of claim 2, wherein the at least one processing device is configured to compare the template with the one or more third party templates based on:
comparing the one or more attributes in the template with the one or more third party attributes associated with the one or more third party templates.

4. The system of claim 3, wherein the at least one processing device is configured to determine the match between the template and the third party template based on:
determining a match between at least one attribute of the one or more attributes with at least one third party attribute of the one or more third party attributes.

5. The system of claim 1, wherein the at least one processing device is configured to determine the one or more attributes based on at least one of historical interaction data, historical resource usage data, and location data.

6. The system of claim 1, wherein the template is a queryable template.

7. The system of claim 1, wherein presenting the resource associated with the third party template comprises:
transmitting the resource to an entity application; and
applying the resource to at least one resource pools.

8. The system of claim 1, wherein the at least one processing device is configured to:
generate a questionnaire associated with at least one attribute of the one or more templates;
receive an input associated with the questionnaire from the user; and
update the template based on the input received from the user.

9. A computer program product for determining resource allocation based on usage attribute data, the computer program product comprising a non-transitory computer-readable storage medium having computer executable instructions for causing a computer processor to perform the steps of:
determining one or more attributes associated with a user;
generating a template associated with the user using the one or more attributes;
comparing the template with one or more third party templates;
determining a match between the template and a third party template of the one or more third party templates; and
presenting a resource associated with the third party template to the user.

10. The computer program product of claim 9, wherein the computer executable instructions computer executable instructions cause a computer processor to perform the steps of:
receiving one or more third party attributes from one or more third party entities via a dashboard; and
generating the one or more third party templates using the one or more third party attributes received from the one or more third party entities.

11. The computer program product of claim 10, wherein the computer executable instructions for causing a computer processor to perform the steps of comparing the template with the one or more third party templates based on:
comparing the one or more attributes in the template with the one or more third party attributes associated with the one or more third party templates.

12. The computer program product of claim 11, wherein the computer executable instructions for causing a computer processor to perform the steps of determining the match between the template and the third party template based on:
determining a match between at least one attribute of the one or more attributes with at least one third party attribute of the one or more third party attributes.

13. The computer program product of claim 9, wherein the computer executable instructions for causing a computer processor to perform the steps of determining the one or more attributes based on at least one of historical interaction data, historical resource usage data, and location data.

14. The computer program product of claim 9, wherein the computer executable instructions for causing a computer processor to perform the steps of:
generating a questionnaire associated with at least one attribute of the one or more templates;
receiving an input associated with the questionnaire from the user; and
updating the template based on the input received from the user.

15. A computer implemented method for determining resource allocation based on usage attribute data, the method comprising:
determining one or more attributes associated with a user;
generating a template associated with the user using the one or more attributes;
comparing the template with one or more third party templates;
determining a match between the template and a third party template of the one or more third party templates; and
presenting a resource associated with the third party template to the user.

16. The computer implemented method of claim 15, wherein the method further comprises:
receiving one or more third party attributes from one or more third party entities via a dashboard; and
generating the one or more third party templates using the one or more third party attributes received from the one or more third party entities.

17. The computer implemented method of claim 16, wherein comparing the template with the one or more third party templates comprises:
comparing the one or more attributes in the template with the one or more third party attributes associated with the one or more third party templates.

18. The computer implemented method of claim 17, wherein determining the match between the template and the third party template comprises:
determining a match between at least one attribute of the one or more attributes with at least one third party attribute of the one or more third party attributes.

19. The computer implemented method of claim 15, wherein the method further comprises determining the one or more attributes based on at least one of historical interaction data, historical resource usage data, and location data.

20. The computer implemented method of claim 15, wherein the method further comprises:
generating a questionnaire associated with at least one attribute of the one or more templates;
receiving an input associated with the questionnaire from the user; and
updating the template based on the input received from the user.
